(19) United States
(12) Patent Application Publication
(10) Pub. No.: US 2017/0100294 A1
(43) Pub. Date: Apr. 13, 2017

(54) Portable Hybrid Hyperbaric Chamber

(71) Applicants: Efrain Acevedo, Isabela, PR (US); Kenneth Wright, Anasco, PR (US)

(72) Inventors: Efrain Acevedo, Isabela, PR (US); Kenneth Wright, Anasco, PR (US)

(21) Appl. No.: 15/290,195

(22) Filed: Oct. 11, 2016

Related U.S. Application Data
(60) Provisional application No. 62/240,103, filed on Oct. 12, 2015.

(51) Int. Cl. A61G 10/02

(52) U.S. Cl. CPC A61G 10/026

(57) ABSTRACT

A pressured hybrid-construction hyperbaric chamber and method of using same are disclosed. The present invention provides for the fabrication and building of hybrid-construction, solid or semi-flexible wall, exoskeleton reinforced, hybrid hyperbaric chambers suitable for office and/or home use in providing oxygen rich therapies.

### CROSS-REFERENCE TO RELATED APPLICATIONS

This application claims priority to co-pending U.S. Provisional patent application Ser. No. 62/240,103 titled “Portable Hybrid Hyperbaric Chamber”, filed on Oct. 12, 2016 the disclosure of which is herein incorporated by reference in its entirety.

### PATENTS CITED

The following documents and references are incorporated by reference in their entirety, Dubois et al (U.S. Pat. Pub. No. 2013/0206146), Schneider et al (U.S. Pat. No. 6,321,746), Milne et al (U.S. Pat. Pub. No. 2011/02226252) and Gamow et al (U.S. Pat. No. 4,974,829), Risley et al (U.S. Pat. No. 7,198,045) and Mosteller et al (U.S. Pat. Pub. No. 2005/0109381).

### Field of the Invention

The present disclosure relates generally to a portable, low pressure hyperbaric chamber and method of using same and specifically to a flexible wall, hybrid construction, exoskeleton reinforced, low pressure hyperbaric chambers suitable for office use in providing oxygen rich therapies.

### Description of the Related Art

Hyperbaric chambers and chamber systems are well known and used in the medical and sports industries. In essence, occupants of hyperbaric chambers undergo hyper baric treatments in which they are subjected to relatively high pressures and richer oxygen mixtures to breathe. Hyperbaric treatments are known, amongst other things, to enhance muscular recuperation and to increase oxygen inhalation.

A number of hyperbaric chambers have been envisioned, in both fixed/circular embodiments, as well as in flexible materials. Both are designed to be used in specific conditions and rooms. However, human buildings (particularly office buildings) tend to have rectangular shapes, making round devices volumetrically inefficient, and soft structures (i.e. inflatable) require the patient to lay down and may be susceptible to puncturing when someone walked on them. What is needed, is a portable hyperbaric unit capable of being easily transported and located in homes and regular offices while minimizing the wasted volumetric space.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In one aspect the invention is about a portable hyperbaric chamber comprising a sealed chamber formed by a ceiling, a floor and three or more solid or semi-flexible walls capable of retaining their shape, wherein said walls have one or more openings through them pneumatically connecting the sealed chamber with the outside, a compressor, an oxygen supply apparatus; and a solid or semi-flexible door capable of sealing an opening for providing access to the chamber. In another aspect, said ceiling, floor, door and wall surfaces are each made from a flexible material is selected from a group comprised of one or more of: fiberglass composite, carbon composite, wood composites, plastic, metal or other similar materials. In yet another aspect, a metal exoskeleton where at least one of said exoskeleton vertical or horizontal corner members overlap and compress at least one of the angled joints between one of said walls and said ceiling, floor and/or neighboring wall. In another aspect, none of said angled joints the angles at the joints between one of said walls and said ceiling, floor and/or neighboring wall measure 90 degrees. In yet another aspect, a compressible elastomeric material is placed where said metal exoskeleton meets said angled joint. In another aspect, said elastomeric material is selected from a group comprised of one or more of: natural rubber mat, synthetic rubber mat, O-ring, SIKAFLEX® or similar materials. In another aspect said chamber is created by the securing of one or more panels to said exoskeleton frame in order to form a ceiling, a floor, three or more alls and a door. In yet another aspect, said panels are made of metal and welded to said exoskeleton.

In one aspect the invention is about a portable hyperbaric chamber comprising a sealed chamber formed by the folding of the wall materials into a chamber having a ceiling, a floor and three or more solid or semi-flexible walls capable of retaining their shape, wherein said walls have one or more openings through them pneumatically connecting the sealed chamber with the outside, a compressor, an oxygen supply apparatus and a solid or semi-flexible door capable of sealing an opening for providing access to the chamber.

Other features and advantages of the present invention will become apparent upon examining the following detailed description of an embodiment thereof, taken in conjunction with the attached drawings.

### BRIEF DESCRIPTION OF THE DRAWINGS

FIGS. 1-2 show perspective views of a proposed portable hyperbaric chamber, according to an exemplary embodiment of the invention.

FIG. 3 shows a perspective view of an exoskeleton for a proposed portable hybrid hyperbaric chamber, according to an exemplary embodiment of the invention.

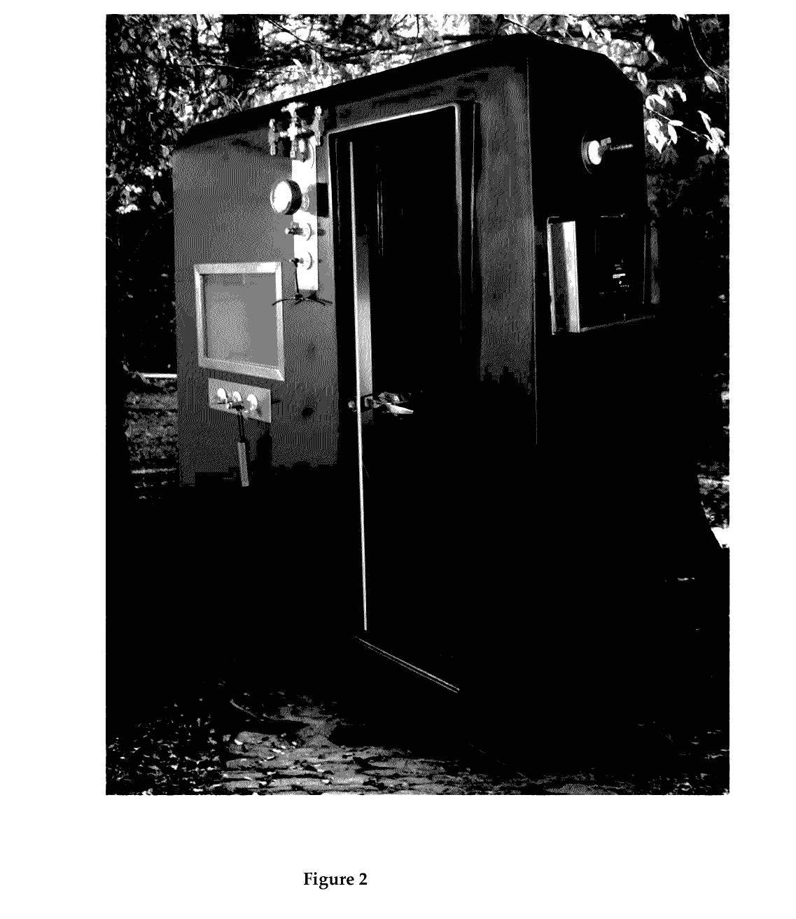

FIGS. 4 shows a perspective view of a proposed portable hybrid hyperbaric chamber, according to an exemplary embodiment of the invention.

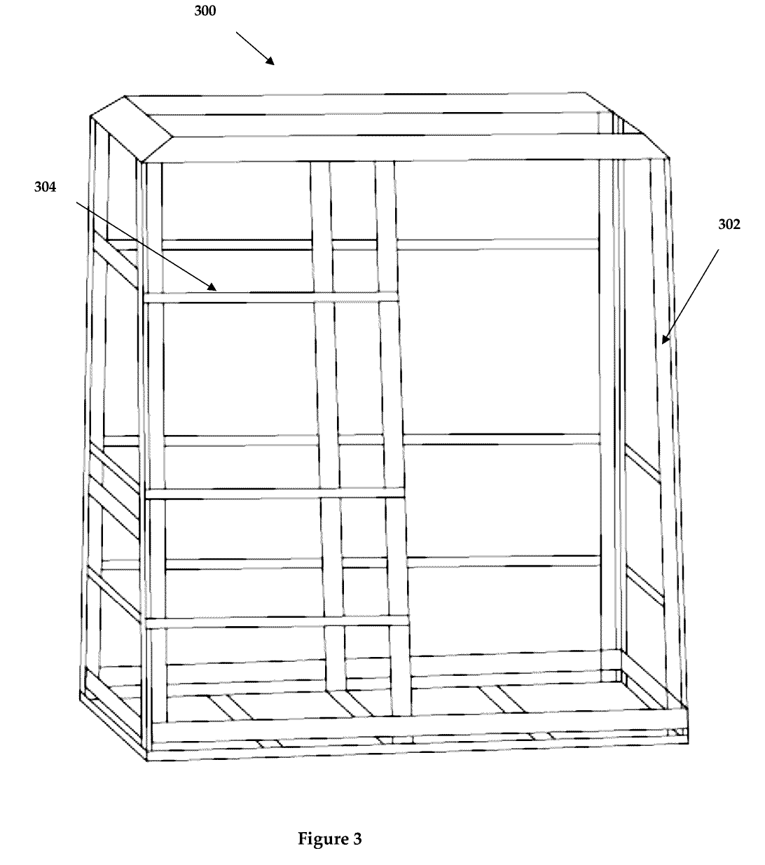

FIGS. 5-7 show cross section views of proposed portable hyperbaric chamber walls, according to exemplary embodiments of the invention.

FIG. 8 shows a view of a user sitting within the proposed portable hybrid hyperbaric chamber interior, according to an exemplary embodiment of the invention.

FIGS. 9 shows a side view of a proposed portable hybrid hyperbaric chamber, according to an exemplary embodiment of the invention.

FIG. 10 shows a perspective view of a welded panel portable hybrid hyperbaric chamber, according to an exemplary embodiment of the invention.

The above-described and other features will be appreciated and understood by those skilled in the art from the following detailed description, drawings, and appended claims.

### DETAILED DESCRIPTION OF THE PREFERRED EMBODIMENT

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

Simplifications or omissions may be made to avoid obscuring the purpose of the section. Such simplifications or omissions are not intended to limit the scope of the present invention. All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

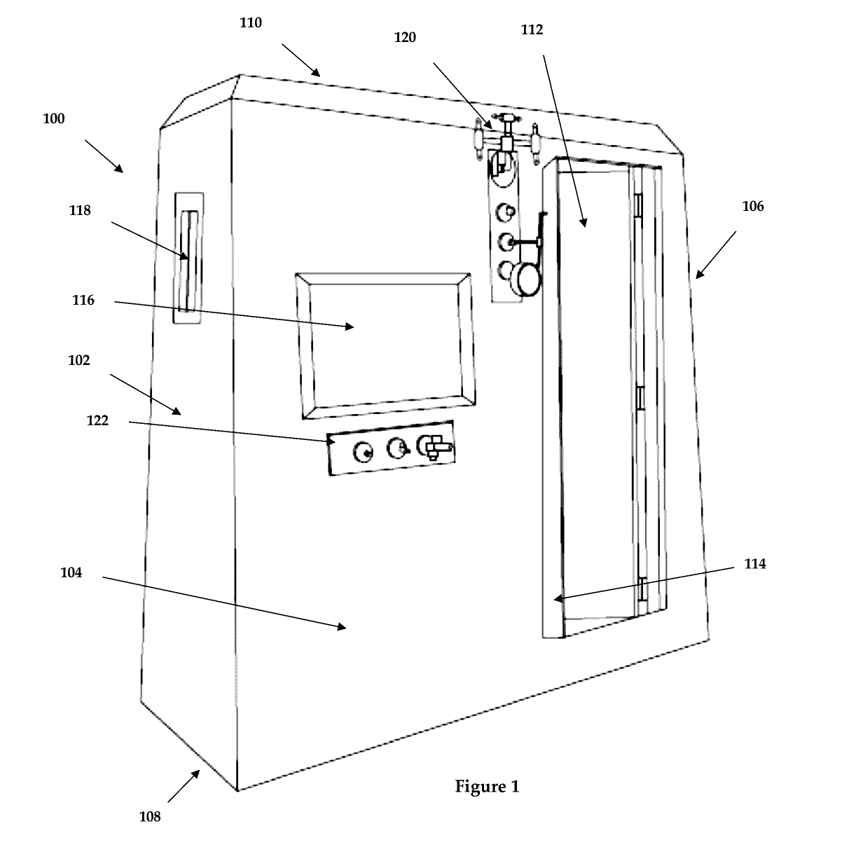

Referring to FIGS. 1-2 we show a proposed embodiment of a portable hyperbaric chamber 100 suitable for location within a room or other similar home or office building. Unlike other proposed units, the chamber is constructed of three or more vertical walls 102, 104, 106, a floor 108 and a ceiling 110 formed of a combination of flexible or semi-flexible materials capable of holding its shape in free space which not under pressure hold the shape for a constrained volume or chamber wherein the patient or user is enclosed. A door 112 allows entry into the chamber interior and forms a seal around its periphery contact with the entrance 114 within which it is placed so that the chamber may be brought up in pressure. Said door may be made of composites, metal or any other suitable material. In another embodiment, a suitable gasket material (or O-ring) may be suitably placed around the door frame periphery.

The unit shape may be adjustable, but in general, it is desired that it be shaped as a parallelogram with no corner measuring 90 degrees, in order to facilitate the airflow within the chamber and avoid dead-flow zones. In order to facilitate its transport, it is sized to fit within a standard home door (and hence capable of fitting within most slightly larger office openings). In one embodiment, this limits the unit's width to be at/below 81 cm (32 in.), its height at/below 2.03 meters (6′8″) and its length around 2.14 meters (7 ft.), although of course these may be adjusted as suitable.

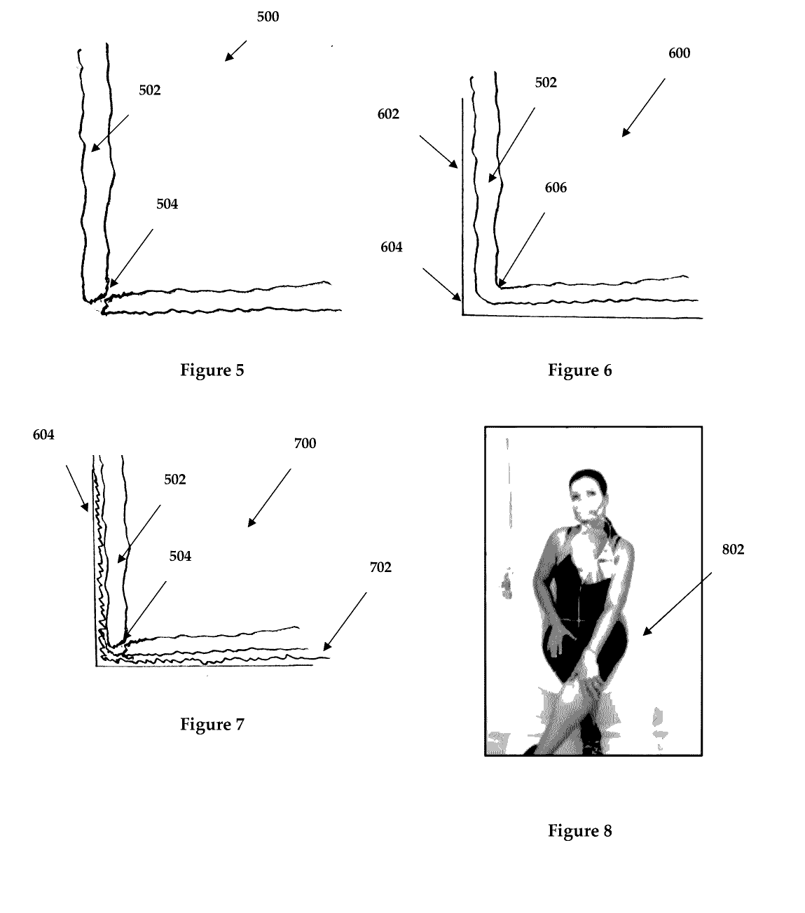

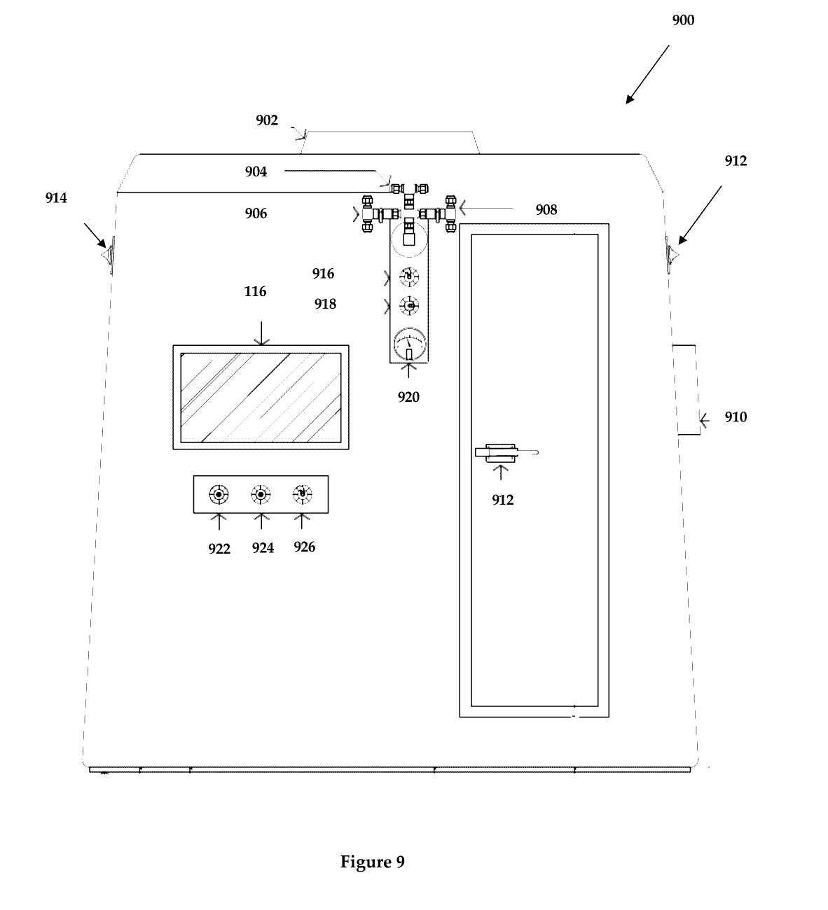

The unit may have one or more doors 112 for entry, with a reverse seal so that insufflations of the chamber interior forces the door closed. The door may have a handle 910 (FIG. 9), an optional lock allows easy opening from the outside and/or the inside. One or more windows 116, 118 may be built into the walls 102, 104, 108 to allow for observation into the interior. One or more lights inside the chamber may be provided, including LED lights 802, as well as entertainment systems (Audio and/or video 810), as well as active noise cancellation units may be fitted. The interior (FIG. 8) may be fitted with a chair 802 or bed, and/or a reclined position chair/lounge.

A compressor is used to raise the pressure inside the chamber, with one or more pressure release valves within a number of positions 120, 122 which are used to set the inside chamber pressure. In one embodiment, the compressor is used to control the pressure, with the valve acting as a backup. In another embodiment, the operator simply selects the valve to be operated 904, 906 or 908 which will release at the preset value, keeping the pressure at the desired level. Any desired pressure may be selected, although the most commons for therapy are 0.31 bar (4.5 psi), 0.62 bar (9.0 psi) and 1.01 (14.7 psi).

In one embodiment, any of the following may be fitted to the unit (alone or in combinations), these include one or more air inlet nipples 912, 914 (to connect a compressor), one or more external vent valves with muffler 916, 926 allow for the chamber to be de-pressurized, an analyzer port 918 allows for samples of the interior air metrics (percent oxygen, pressure, humidity and other variables), one or more chamber pressure gages 920 allow quick readings of the interior pressure. An internal vent 922 may be provided, as well as an oxygen nipple inlet 924. The unit may be fitted with a non-slip surface (such as non-slip rubber or similar materials) to ensure it remains where placed in the office.

Pneumatic interaction openings are capped with one or more valves 904, 906, 908, so that two or more pressures may be selected, such as those found at 10′, 20′ and 33′ (and/or at 10m, 20m and/or 33m) of water depth (recommended by PADI for decompression). Such pneumatic units are connected to a control system connected to a compressor (be it single or dual stage) [such as a QUINCY®, GAST® Model 0523 or similar] and/or a portable oxygen concentrator/generation unit [Such as an Invacare PERFECTO2® or similar]. Said compressor may be located in an adjacent room, as long as a feeder line comes into the chamber.

The notable points about the unit include the non-folding (significantly rigid) shell enclosing the chamber volume. The above means that in one embodiment, the unit is constructed completely of metal, essentially taking a solid single sheet of metal (either ferrous, non-ferrous or a composite of both) which is folded in a sheet metal bender and has one or more solid edges welded together. This is similar to the construction of the Chinese take-out container from a folded single sheet.

A more elegant embodiment may be accomplished through the use of a metal exoskeleton 300 (made from ferrous or non-ferrous metals) designed to have one ore more solid ‘corner’ (either 90 deg. or some other angle) surfaces overlapping along the edge of one or more of the angled joints formed by the junctures of the composite material panels. The angled joints are preferred to form 125 deg. (and complementary 55 deg., that is any angle other than 90 deg. (although in one embodiment the structure may be mfd. using all square angles), to facilitate internal chamber airflow. Such an exoskeleton 300 may be formed of either vertical 302 members and/or horizontal 304 members, although any other suitable direction may be accomplished. In addition, they may be interconnected or formed to attach to the interior composite member. The corners of the exoskeleton 406 are designed to be complementary to the place where the ceiling meets one or more of the walls, where the walls meet each other, where the floor meets the walls, even where the door frame forms, to ensure that when expanding due to the chamber's inner pressure being increased, the join or joint where the walls/ceiling/floor meet does not crack.

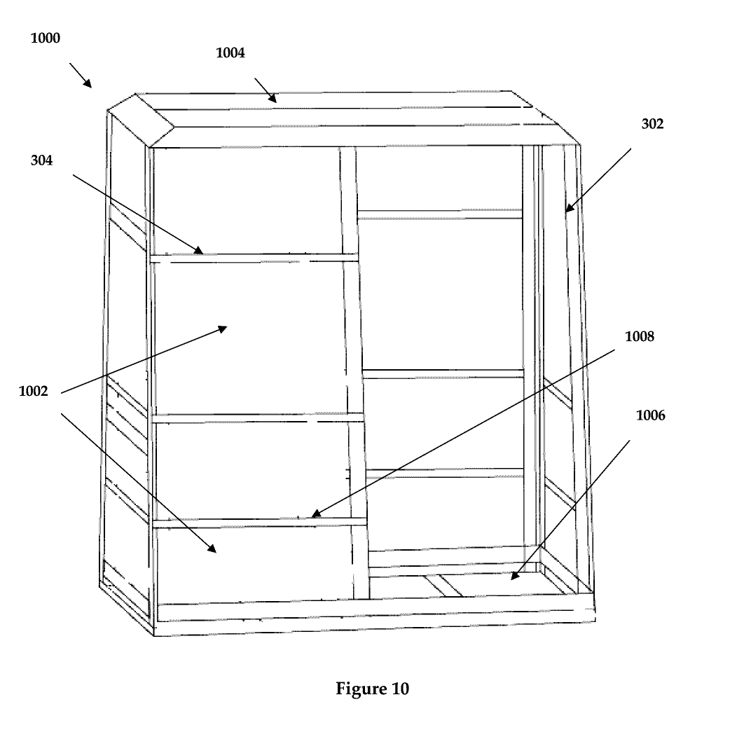

In one embodiment, a complete metal system chamber (FIG. 10) is created when one or more sheet metal panels 1002, 1004, 1006 are welded at the edges 1008 of said exoskeleton frame members 302, 304 forming an enclosed chamber. The door and door frame assembly 112, 114 is then attached, as well as the various entry openings for compressor input, etc.

Note that the panels 1002, 1004, 1006 may be alternatively formed of a plastic (be it a thermoplastic or thermosetting polymer (examples of these include polyethylene, polystyrene, polyvinyl chloride and polytetrafluoroethylene (PTFE). These would include materials such as nylon, Plexiglas, and others). A polycarbonates (PC), known by the trademarked names Lean, Maroon, Marcela and others, are a particular group of thermoplastic polymers. They are easily worked, molded, and thermoformed and attached to the exoskeleton frame members 302, 304 through mechanical devices (fasteners, screws), chemical bonding agents (glues, epoxies) and/or thermal members (such as ultrasonic welding), etc.

In another embodiment, the unit is made completely and or partially of composite materials. These composites may include a composite resin arrangement (such as fiberglass or similar), composite glue wood products (such as plywood or similar) and/or a carbon composites (such as para-aramid synthetic fibers as KEVLAR®, NOMEX® or TECHNORA® or similar).

In cases where the walls are composite formed (such as fiberglass or carbon composites), the unit may be made over a mold (such as is common in boat hull construction, using either a mold inside (where the chamber is laid over the mold) or a mold outside (where the unit is laid inside a mold that represents a complementary image of the desired product.

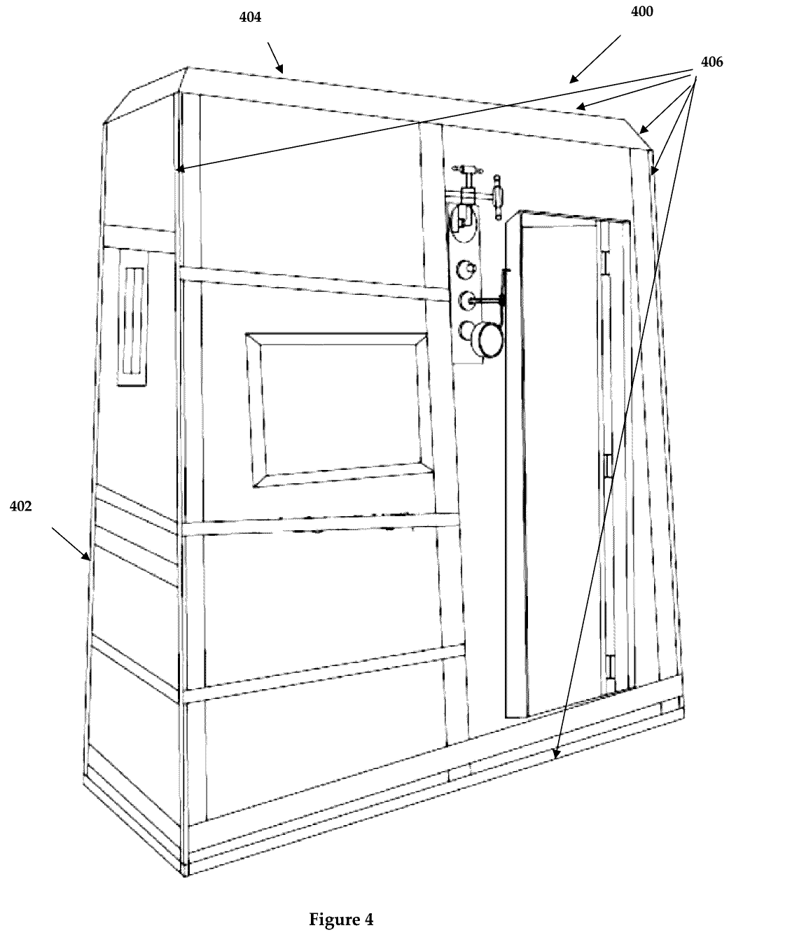

Referring to FIGS. 5-7, we see that when the parallelogram angles 500 are combined with composite construction 502, a common occurrence is that repeated inflate/deflate cycles (similar to what occurred in the Comet jet aircraft) will cause hairline fractures 504 due to the flexing of the joint point. This is why most airframe designs involving pressurization/de-pressurization are circularly shaped, of course.

In one embodiment 600, the above fatigue of the joints problem may be solved by the placement of one or more exoskeleton assembly 300 components' 602 over the composite shell 100 flex points 406 (i.e. anywhere where two of the composite panels meet), resulting in a combined ‘cinched’ structure 400 where the joints 402, 404 and flex-points 406 where the composite panels join are placed in compression by the outer exoskeleton frame 602.

In one embodiment 500, the exoskeleton ‘corner’ 604 (formed either from a bent metal member, a mechanically locked member (such as one metal member sliding in a groove in another along the length of the ‘corner’ 604) and/or a joined pair of metal members welded together along the ‘corner’ 604) compresses the edge 606 of the composite mold edge to prevent the flexing to cause an enclosure edge fracture 504. In another embodiment 700, a compressible/elastomeric material 702 or gasket (such as a rubber mat or O-ring, expanding foam, or a material equal or similar to SIKAFLEX®) is used to create a constant compression match at or along the corner between the materials.

In use, the patient or user is placed within the chamber, the door is locked, and the chamber is pressurized to the desired internal pressure through the activation of the compressor. While any mixture of oxygen to air may be selected, up to 100% oxygen, normally the oxygen percentage is left at 50%. In some cases, the patient is given 100% oxygen directly (through a mask), and the patients exhaust is then kept at 50% oxygen percentage.

### CONCLUSION

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

1. A portable hyperbaric chamber comprising:
a sealed chamber formed by a ceiling, a floor and three or more solid or semi-flexible walls capable of retaining their shape, wherein said walls have one or more openings through them pneumatically connecting the sealed chamber with the outside;
a compressor;
an oxygen supply apparatus; and
a solid or semi-flexible door capable of sealing an opening for providing access to the chamber.

2. The chamber of claim 1 wherein;
said ceiling, floor, door and wall surfaces are each made from a flexible material is selected from a group comprised of one or more of: fiberglass composite, carbon composite, wood composites, plastic, metal or other similar materials.

3. The chamber of claim 2 further comprising;
a metal exoskeleton where at least one of said exoskeleton vertical or horizontal corner members overlap and compress at least one of the angled joints between one of said walls and said ceiling, floor and/or neighboring wall.

4. The chamber of claim 3 wherein;
none of said angled joints the angles at the joints between one of said walls and said ceiling, floor and/or neighboring wall measure 90 degrees.

5. The chamber of claim 4 wherein;
a compressible elastomeric material is placed where said metal exoskeleton meets said angled joint.

6. The chamber of claim 5 wherein,
said elastomeric material is selected from a group comprised of one or more of: natural rubber mat, synthetic rubber mat, O-ring, SIKAFLEX® or similar materials.

7. The chamber of claim 3 wherein;
a compressible elastomeric material is placed where said metal exoskeleton meets said angled joint.

8. The chamber of claim 7 wherein,
said elastomeric material is selected from a group comprised of one or more of: natural rubber mat, synthetic rubber mat, O-ring, SIKAFLEX® or similar materials.

9. The chamber of claim 3 wherein;
said chamber is created by the securing of one or more panels to said exoskeleton frame in order to form a ceiling, a floor, three or more alls and a door.

10. The chamber of claim 9 wherein;
said panels are made of metal and welded to said exoskeleton.

11. A portable hyperbaric chamber comprising:
a sealed chamber formed by the folding of the wall materials into a chamber having a ceiling, a floor and three or more solid or semi-flexible walls capable of retaining their shape, wherein said walls have one or more openings through them pneumatically connecting the sealed chamber with the outside;
a compressor;
an oxygen supply apparatus; and
a solid or semi-flexible door capable of sealing an opening for providing access to the chamber.
